(19) United States
(12) Patent Application Publication
(10) Pub. No.: US 2002/0091590 A1
(43) Pub. Date: Jul. 11, 2002

(54) Fundraising system with creation, coordination, and order tracking tools

(76) Inventors: Gary W. Edgar, Cedarburg, WI (US); Todd W. Wenzel, Delafield, WI (US); Bruce K. Edgar, Wauwatosa, WI (US); Scott A. Tucholka, Cedarburg, WI (US); Michael C. Besaw, Cedarburg, WI (US); Steven F. Wienkers, Cedarburg, WI (US); Brandon S. Eggert, Big Bend, WI (US)

Correspondence Address: MICHAEL BEST & FRIEDRICH, LLP, 100 E WISCONSIN AVENUE, MILWAUKEE, WI, 53202, US

(21) Appl. No.: 09/755,988

(22) Filed: Jan. 6, 2001

(51) Int. Cl. G06F 17/60

(52) U.S. Cl. 705/28; 705/26

(57) ABSTRACT

Techniques are provided for checking product availability from various suppliers so that purchase orders may be automatically generated upon a determination that all desired products are available. In accordance with one embodiment, a “customer” program converts the business objects that create the product demand for the desired products into various supply assurance requests. The customer program then sends each of the supply assurance requests to a respective supplier to query the product availability. After sending the supply assurance requests, the customer program waits until it receives all of the supply assurance replies corresponding to the supply assurance requests. If the supply assurance replies indicate that all the desired products can be provided by the supplier, then the customer program generates one purchase order to each of the suppliers that received a supply assurance request, to place orders for the desired products. However, if any one of the desired product cannot be provided by any one of the suppliers, then the customer program, based on the product availability/unavailability, takes actions defined by the customer. For example, the customer program raises an exception to seek human intervention regarding the product unavailability. In an alternative embodiment, a trusted intermediary is used in between the customer and the suppliers, wherein the trusted intermediary provides the capability to track the supply assurance requests and replies, manages addresses updates of the suppliers, etc.

### PRIORITY CLAIM

This application claims priority from U.S. Provisional Application Serial No. 60/175,065 filed Jan. 7, 2000.

### FIELD OF THE INVENTION

The present invention relates generally to product purchases and, more specifically, to verifying product availability in order to automatically generate corresponding purchase orders.

### BACKGROUND OF THE INVENTION

Conventionally, when a manufacturer seeks to order parts, he delivers a purchase order to a supplier. Depending on the situation, the manufacturer may not know until some time has lapsed that the parts are not available. Not knowing whether a part is available in due time can greatly affect the manufacturer's scheduling, budgeting, and planning processes. Further, the manufacturer may have several purchase orders pending at various suppliers. In many cases, the ordered parts are used to manufacture a product such that missing any one of the parts will prevent the product from being completely built. Usually, all of the ordered parts are not required to be available at the same time, but each of the parts must arrive at a desirable date for the manufacturing process to run smoothly.

When any one of the desired parts is not available, the manufacturer, ideally, would not want to order any of the other parts even if these parts are available because ordering parts that must wait for other parts to complete a product carries with it various problems. For example, the manufacturers would have to pay for and manage the ordered parts. The ordered parts may require an inventory system, security guards, or special handling.

Placing a purchase order for parts may generate various paper work to the accounting department that is responsible for paying for the parts. The purchase order may also be used to generate a work schedule or to allocate personnel to manufacture the product that uses the ordered parts. The work schedule or personnel allocation must be revised when the parts are not available.

### SUMMARY OF THE INVENTION

In view of the above-discussed deficiencies, techniques are provided for verifying product availability from various suppliers so that purchase orders may be automatically generated upon a determination that all desired products are available. The techniques provide message grouping, target system query, and customer notification. In message grouping, various supply assurance checks for a product from a supplier are requested at the same time to assure that each assurance check takes account of the product demand in all other supply assurance requests. In response to a supply assurance request, a target system of the supplier provides information to determine if and when a product demand can be met. Additionally, the customer that requested the supply assurance check is informed of the results of the supply assurance checks. If the product demand cannot be met, then the customer can identify the product shortage and the amount of currently available product. Optionally, the customer may be informed when the product demand can be met.

In accordance with one embodiment, a “customer” program converts the business objects that create the product demand for the desired products into various supply assurance requests, each of which contains the information of the products to be ordered. The customer program then sends each of the supply assurance requests to a respective supplier. After sending the supply assurance requests, the customer program waits until it receives all of the supply assurance replies corresponding to the supply assurance requests. If the supply assurance replies indicate that all of the desired products are available, then the customer program generates one purchase order to each of the suppliers that received a supply assurance request in order to place orders for the desired products. However, if any one of the desired product is not available, then the customer program, based on the product availability/unavailability, takes actions defined by the customer, including, for example, raising an exception to seek human intervention regarding the product unavailability.

In an alternative embodiment, a trusted intermediary is used in between the customer and the suppliers, wherein the trusted intermediary provides the capability to track the supply assurance requests and replies, manages addresses updates of the suppliers, etc.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows an exemplary trading community that includes a plurality of partners and a trusted intermediary, in accordance with one embodiment;

FIG. 2 shows an exemplary computer network used by the partners and the trusted intermediary in their trading activities;

FIG. 3 is a flowchart illustrating the steps in a method in accordance with one embodiment;

FIG. 4 is a block diagram of a computer system on which embodiments of the invention may be implemented;

FIG. 5 illustrates creating and sending a supply assurance request (“SA Request”); and

FIG. 6 illustrates creating and sending a supply assurance reply (“SA Reply”)

### DETAILED DESCRIPTION OF THE PREFERRED EMBODIMENT

Techniques are provided for checking product availability from various suppliers so that appropriate purchase orders may be automatically generated upon a determination that all desired products are available.

The Trading Community

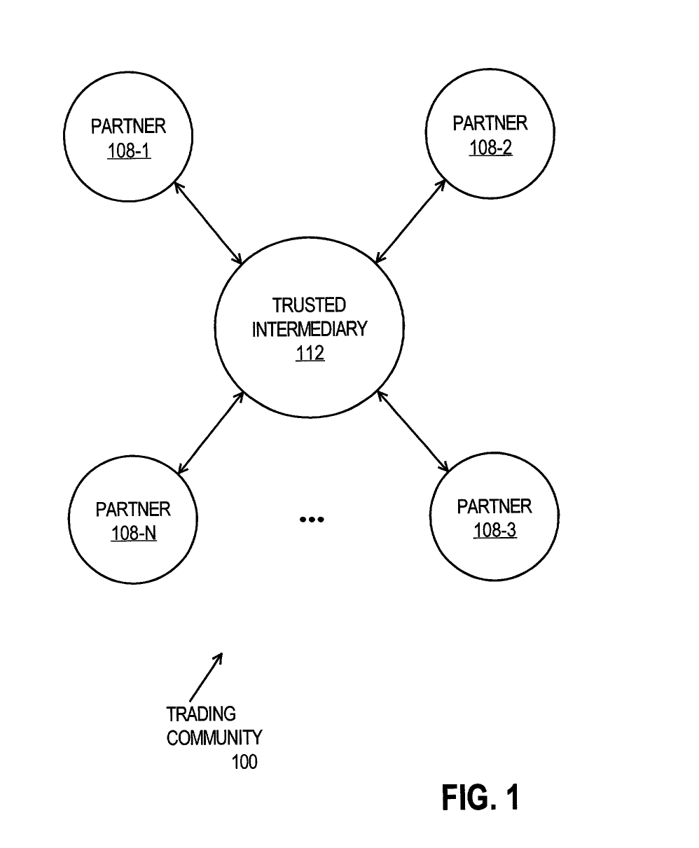

FIG. 1 shows an exemplary trading community 100 that includes a plurality of partners 108-1 to 108-N and a trusted intermediary 112. Each partner 108, being a member of trading community 100, may be, for example, a customer, a supplier, a distributor, an OEM, etc. A customer partner 108C may order various products from a supplier partner, a distributor partner, or an OEM partner 108. The term “supplier partner 108S” is used herein to refer to any partner 108 who can provide the requested products/services to a customer partner 108C. Embodiments of the invention are useful when a customer partner 108C seeks to order products from various partner suppliers 108S. In one embodiment, customer partner 108C generates a supply assurance request to each of the potential partner suppliers 108S to query the availability of the products the customer partner 108C seeks to order. If all desired products are available, then customer partner 108C issues a purchase order to each of the supplier partners 108S to order the products. However, if any one of the desired products is unavailable, then customer partner 108C, based on the data provided by the supplier partners 108S, takes appropriate action. Trusted intermediary 112 provides network and business services to partners 108. These services include, for example, business logic, data mining, error recovery, etc. In one embodiment, each partner 108 and trusted intermediary 112 uses a respective program/computer to implement the inventive technique. Depending on the embodiments, a trusted intermediary 112 may not be used.

Computer Network Used by Members of the Trading Community

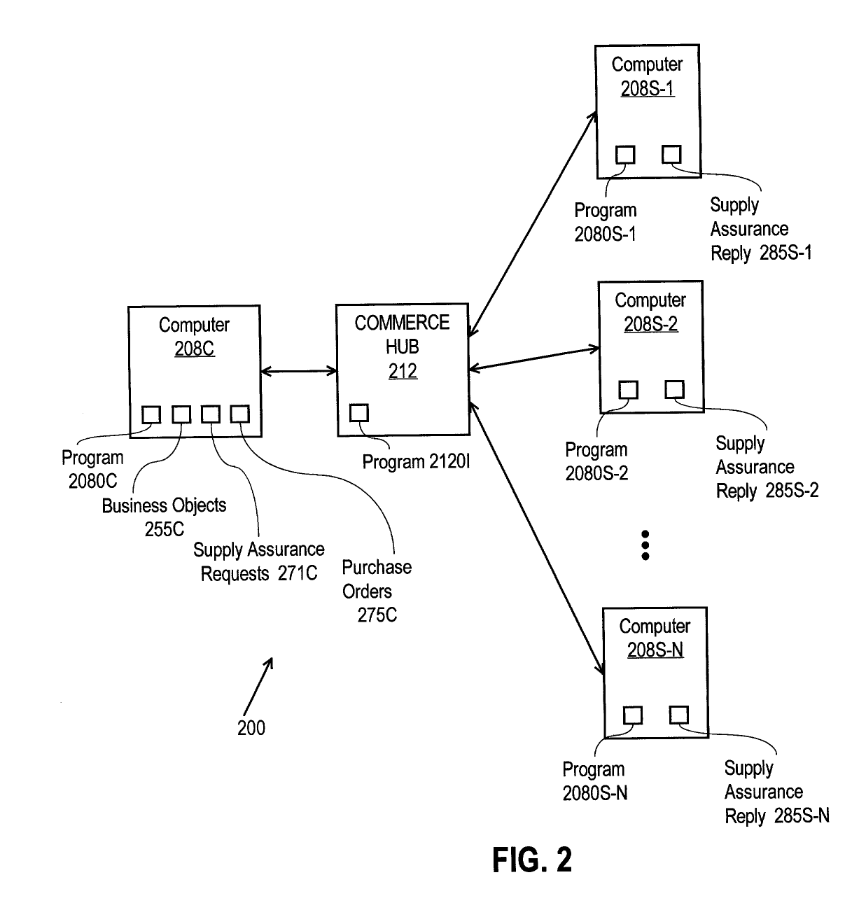

FIG. 2 shows an exemplary computer network 200 used by partners 108 and trusted intermediary 112 in their trading activities. Computer network 200 includes a computer 208C, a plurality of computers 208S-1 to 208S-n, and a Commerce Hub computer (“Commerce Hub”) 212 that are used by a customer partner 108C, supplier partners 108S-1 to 108S-n, and trusted intermediary 112, respectively. In one embodiment, each of the program (e.g., 2080C, 2120I, 2080S-1, . . . , 2080S-2) are run by each computer 208 and 212, respectively. However, those skilled in the art will recognize that a computer program can be run by a computer in various different locations. Further, a computer program may be part of another computer program and/or be run over a network. For example, all programs 2080 and 2120 may be part of a program run by one computer connected over a network to the appropriate site of a partner 108 or trusted intermediary 112. Therefore, the invention is not limited to the location of the programs and/or to the location of the computer. In addition, the invention is not limited to how a program is run.

The Customer Site

Computer 208C is responsible for generating supply assurance request(s) 271C and taking appropriate actions upon receiving supply assurance replies 285S from computers 208S. Computer 208C runs program 2080C that takes as inputs business objects 255C, which create demand of products to be ordered. These business objects 255C include, for example, pre-purchase order, forecast, work order, and bill of materials. A pre-purchase order is used to refer to a conventional purchase order which a customer uses to order products. In accordance with one embodiment of the invention, a “real” purchase order 275C that is sent to a supplier partner 108S will be generated once the supply assurance replies 285S indicate that all desired products are available from the respective supplier partners 108S. Those supply assurance replies 285S, in turn, are issued in response to the supply assurance requests 271C. Those skilled in the art will recognize that these business objects 255C are used for illustrative purpose only, other objects providing data from which products can be ordered are within the scope of the various embodiments of the invention.

Business objects 255C may be part of an Enterprise Resource Planning (ERP) system or Material Requirements Planning (MRP) that are used by customer partner 108C. In one embodiment, program 2080C communicates with the ERP/MRP system of customer partner 108C. Program 2080C also processes business objects 255C through the ERP/MRP system.

Program 2080C, taking a combination of one or more business objects 255C as inputs, and, depending on the product demand, creates one or more supply assurance requests 271C. In one embodiment, supply assurance request 271C is in a standardized format that can be automatically read by computers 208S. When there are multiple business objects 255C, performing supply assurance checks at the same time is important. For example if each business object is processed individually, the results of a subsequent supply assurance check may not include the product demand generated from other business objects being used as inputs in a previous supply assurance check. Consequently, program 2080C, if appropriate, logically groups supply assurance requests 271C to the same groups to be sent to one supplier partner 108S so that supply assurance checks can be requested for various business objects at the same time. From input business objects 255C, supply assurance request 271C, and other information usually stored in computer 208C, program 2080C determines the respective supplier partners 108S and thus sends supply assurance request 271C to the corresponding computer 208S.

In one embodiment, program 1080C automatically generates supply assurance requests 271C if certain conditions specified by customer partner 108C related to business objects 255C are met. In an alternative embodiment, program 1080C generates requests 271C from instructions of a user using a user interface of computer 208C. Supply assurance request 271C generally includes the quantity of a product, the date that the product must be available to customer partner 108C, and the location of the product that customer partner 108C seeks to have the product from. Generally, these data are extracted from business objects 255C. A product may be in a logical location that constitutes, for example, generally available inventory (or inventory on hand), bonded inventory, and consignment inventory. General inventory includes products that a supplier partner 108S has in stock and is available to the public. Bonded inventory includes products that are owned by a customer partner 108C and are stored at the site of a supplier partner 108S. Consignment inventory includes products that are owned by a supplier partner 108S but are stored at the site of customer partner 108C. Customer partner 108C generally provides enough information for program 2080C to determine the appropriate locations of the products for supply assurance checks. In according with one embodiment, program 2080C has access to the inventory of each location of a specified product. Program 2080C thus can quickly generate a report regarding the various inventories. Consequently, embodiments of the invention are advantageous over the prior art in which a human would ask for the same inventory information, usually over a telephone.

After supply assurance requests 271C are transmitted, program 2080C waits to receive all supply assurance replies 285S. In one embodiment, the data in supply assurance replies 285S are stored in a database. Based on the data provided by supply assurance replies 285S, program 2080C takes appropriate actions. For example, if all desired products are “available,” then program 2080C generates one purchase order 275C to each supplier partner 108S to place the orders. In accordance with one embodiment, all desired products are available if each of the queried products can be provided by a specified date. Such availability may be from one or a combination of the general inventory, bonded inventory, and consignment inventory. However, if any one of the products is not available, then program 2080C takes actions defined by customer 108C. Program 2080C may, for example, generate a report and send it to responsible personnel. Program 2080C may also re-send supply assurance request 271C to another supplier 108S for another supply assurance request. Program 2080C usually uses an approved vendor's list (AVL) to select a supplier 108S in order of priority provided in the AVL. Alternatively, program 2080C can raise an exception to involve human interaction, such as sending an email to personnel in charge of generating the requests 271C or to other appropriate personnel. Because supply assurance replies 285S may include data regarding when a product demand can be met, customer partner 108C can beneficially use the data, such as in re-adjusting his forecast or workload.

The Trusted Intermediary Site

In one embodiment, trusted intermediary 112 is used as a middle point for customer 108C and supplier partners 108S to transmit their data/messages. Trusted intermediary 112, via computer 212/program 2120I, receives supply requests 271C and send these requests, via computer 208S, to supplier partners 108S. Trusted intermediary 112 also receives the list of supplier partners 108S to whom program 2120I sends supply assurance requests 271C. When supply assurance replies 285S traverse from supplier partners 108S to customer partner 108C, trusted intermediary 112 also receives these replies 285S from supplier partners 108S and relays these replies to customer partner 108C. Various embodiments of the invention may not use trusted intermediary 112. That is, data/messages from and to customer partner 108C are directly transmitted to and from supplier partners 108S. However, using trusted intermediary 112 provides several benefits to the trading activities between partners 108. For example, trusted intermediary 112 keeps addresses of supplier partners 108S, and if any of these addresses changes, only trusted intermediary 112 needs to manage the changes, eliminating that burden from all customers partners 108C. Trusted intermediary 112 also tracks supply assurance requests 271C and supply assurance replies 285S. In one embodiment, trusted intermediary 112 provides the XML transport protocols to route data between partners 108.

The Supplier Site

Each computer 208S of supplier partner 108S is responsible for replying to a supply assurance request 271C. Upon receiving supply assurance request 271C, program 2080S checks the inventory of supplier partner 108S. Program 208S provides the inventory check results, via a supply assurance reply 285S, to the requesting customer partner 108C. In one embodiment, supply assurance reply 285C is in a format that can be read by computer 212 and 208C. If the product demand can be met, then program 2080S so reports. However, if the product demand cannot be met, then program 2080S identifies the product shortage and the amount of currently available product. Program 2080S may also indicate when the product demand can be met. In one embodiment, program 2080S interfaces with the MRP/ERP system of supplier partner 108S. Allowing program 2080S to interface with the ERP/MRP system of a supplier partner 108S is beneficial in which program 2080S can electronically provide various information that a customer partner 108C would want to know from the ERP/MRP system. In the prior art, these information items are generally not available in a form that can be used by a computer but must be provided by human.

Method Steps of One Embodiment

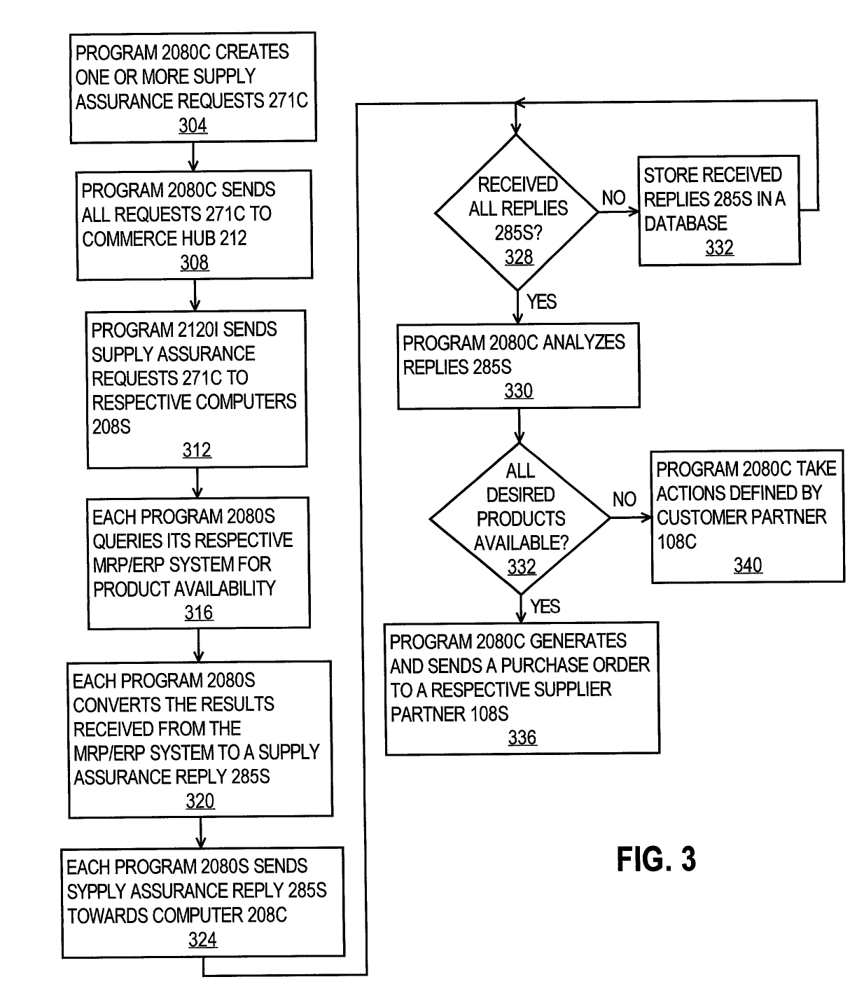

FIG. 3 is a flowchart illustrating the steps that a customer issues supply assurance requests to query product availability, in accordance with one embodiment.

In step 304 program 2080C uses a combination of one or more business objects 255C as inputs to create one or more supply assurance requests 271C.

In step 308 program 2080C sends all requests 271C to computer 212. Program 2080C also informs computer 212 of the supplier partners 108S that will receive a request 271C.

In step 312, program 2120I routes supply assurance requests 271C to respective computers 208C corresponding to supplier partners 108S.

In step 316 each program 2080S, having the content of a respective supply assurance request 271C, queries the respective MRP/ERP system of partner 108S for product availability. Program 2080S generally uses the product number, the supplier location, and the date the product must be available to query the MRP/ERP system.

In step 320 the MRP/ERP system responds to the query with the results from which program 2080S converts to a supply assurance reply 285S.

In step 324 each program 2080S sends the supply assurance reply 285S towards computer 208C. In the embodiment that uses trusted intermediary 112, supply assurance reply 285S propagates through computer 212.

During steps 304 to 324, program 2080C “polls” for the supply assurance replies 285S. Program 2080C in step 328 determines whether all supply assurance replies 285S have been received. If all supply assurance replies 285S have not been received, then program 2080C in step 332 stores the data in each of the replies 285S in a database.

If program 2080C in step 328 determines that all replies 285S have been received, then program 2080C in step 330 analyzes the data in all supply assurance replies 285S.

If analyzing supply assurance replies 285S indicates that purchase orders may be made, e.g., all desired products are available, then program 2080C in step 336 generates various purchase orders 275C each corresponds to a request 271C and sends the purchase orders 275C to the respective suppliers 108S. Alternatively, if the results of the analysis in step 330 indicate that any one of the desired products is not available, then program 2080C in step 340 takes actions defined by the customer 108C.

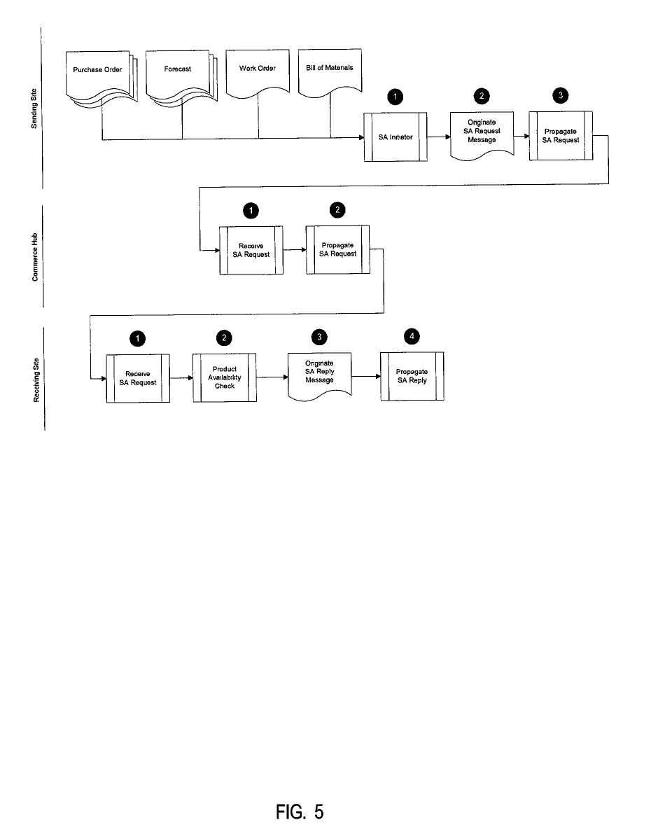

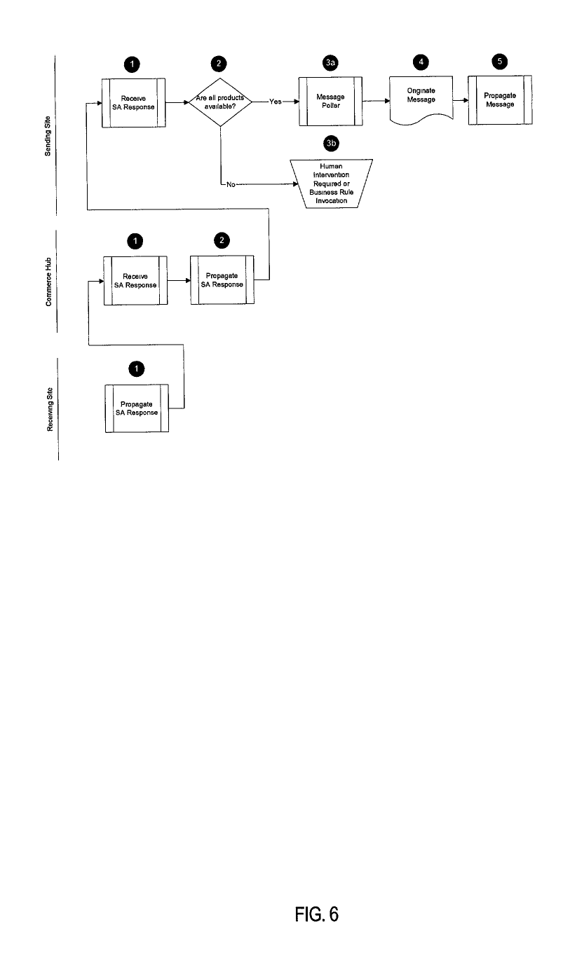

FIGS. 5 and 6 illustrate how the techniques described herein may be implemented according to an embodiment of the invention. In particular, FIG. 5 illustrates creating and sending a supply assurance request (“SA Request”) and FIG. 6 illustrates creating and sending a supply assurance reply (“SA Reply”).

In the description of FIGS. 5 and 6, the following terms are used:

Sending site: This site is typically the customer that initiates a supply assurance check.

Receiving site: The receiving site is typically the supplier or distributor that is the target of the supply assurance check initiated by the customer (the sending site).

It should be noted that the roles are somewhat reversed during the “Create and Send SA Reply” section.

Referring to FIG. 5, the first phase of the supply assurance process is to create and send a supply assurance request to the supplier. After sending the SA Request message, the supplier/distributor database is queried to determine product availability.

Sending Site

Step 1—SA Initiator: The SA Initiator generates a SA Request based on input from the message group.

Step 2—Originate SA Request Message: The SA Request generated by the SA Initiator contains the contents of the messages that passed into the SA Initiator. For example, if a supply assurance request is being generated for multiple purchase orders, the SA Request Message will contain the contents of those purchase orders.

Step 3—Propagate SA Request: After the SA Request has been originated, it is propagated to the commerce hub (just like any other ecom2ecom message).

Commerce Hub

Step 1—Receive Transaction: The commerce hub receives the SA Request message from the sending site.

Step 2—Propagate Message: After the SA Request is received, the Commerce Hub routes the message to the appropriate receiving site.

Receiving Site

Step 1—Receive SA Request: The receiving site receives the SA Request message.

Step 2—Determine Product Availability: The ecom2ecom system will use the contents of the SA Request message to query the receiving site's MRP/ERP system to determine if the receiving site can satisfy the requests of the sending site. The product availability query uses the part number, supplier location, and time elements to determine if a supplier can meet the dynamic requirements of their customer.

Step 3—Originate SA Reply Message: The SA Reply message will contain the results of the product availability check (step 2).

Step 4—Propagate SA Reply: The SA Reply message is propagated back towards the sending site (via the commerce hub). This message will inform the sending site whether the product requirements of the original message (i.e. POs, Forecasts, BOMs, or WO) can be satisfied.

Referring to FIG. 6, after receiving the SA Request and determining product availability, the results of the supply assurance process must be sent back to the originating sending site.

Receiving Site

Step 1—Propagate SA Reply: After product availability has been determined at the receiving site, the receiving site propagates the SA Reply message back towards the sending site.

Commerce Hub

Step 1—Receive Transaction: The commerce hub receives the SA Reply message from the receiving site.

Step 2—Propagate Message: After the SA Reply is received, the Commerce Hub routes the message back to the site that originally send the SA Request message.

Sending Site

Step 1—Receive SA Request: The sending site receives the SA Reply message.

Step 2—Is Product Available?: Based on the contents of the SA Reply message, the sending site is “informed” of product availability at the receiving site.

Step 3a—Message Poller: If the product is available, the message poller at the sending site will “detect” the original message (contents of the original SA Request).

Step 3b—Human Intervention Required or Business Rule Invocation: If product is not available at the receiving site, human intervention at the sending site may be required to resolve the situation (future versions of the ecom2ecom service may provide automated responses to product unavailability). Optionally, the ecom2ecom customer may choose to invoke an ecom2ecom business rule to automatically handle the product shortage.

Step 4—Originate Message: If appropriate, an ecom2ecom message is created that is based on the original message that was the basis of the SA Request (Purchase Order or Forecast). If a supply assurance check is based on a Bill of Materials or Work Order, a transaction may not be created, causing steps 4 and 5 to be skipped.

Step 5—Propagate Message: The message of step 4 is propagated to the receiving site to complete the supply assurance process.

Hardware Overview

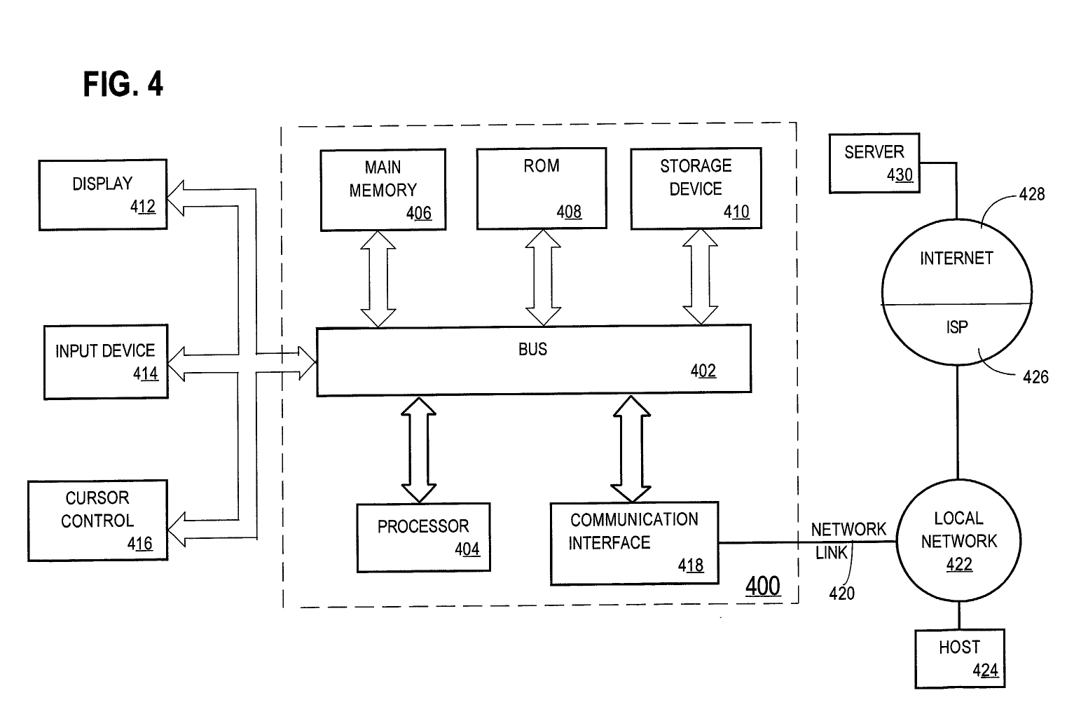

FIG. 4 is a block diagram that illustrates a computer system 400 upon which an embodiment of the invention may be implemented. In particular, computer system 400 may implement a computer 208 or a commerce hub 212 configured to operate as described above. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are implemented by computer system 400 in response to processor 404 executing one or more sequences of one or more instructions contained in main memory 406. Such instructions may be read into main memory 406 from another computer-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software. The term “computer-readable medium” as used herein refers to any medium that participates in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418. In accordance with the invention, one such downloaded application implements the techniques described herein.

The received code may be executed by processor 404 as it is received, and/or stored in storage device 410, or other non-volatile storage for later execution. In this manner, computer system 400 may obtain application code in the form of a carrier wave.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for verifying product availability from a plurality of suppliers in order to determine whether to generate one or more corresponding purchase orders, the method comprising the steps of:
sending a supply assurance request to each supplier of said plurality of suppliers for querying availability of at least one product specified in the supply assurance request;
waiting to receive all supply assurance replies in response to all supply assurance requests that were sent; and
if the supply assurance replies indicate that products specified in each supply assurance request is available, then automatically generating said one or more purchase orders.

2. The method of claim 1 wherein the one or more purchase orders is made when each of all products specified in all supply assurance requests that were sent is available at a specified date from a corresponding supplier.

3. The method of claim 1 further comprising the step of, if any one of the at least one products specified in the supply assurance request is not available from a first supplier, then performing an action selected from a group consisting of:
submitting the supply assurance request for the product that is not available from the first supplier, to a second different supplier that is in an approved vendor list, and
raising an exception for human involvement.

4. The method of claim 1 wherein the at least one product specified in the supply assurance request that was sent to a supplier is available in a combination of two or more of general inventory, bonded inventory, and consignment inventory.

5. The method of claim 1 wherein the supply assurance request that was sent to a supplier is automatically generated from at least one business object.

6. The method of claim 1 further comprising the step of having a trusted intermediary transmit a supply assurance request to one of said plurality of suppliers.

7. The method of claim 1 further comprising the step of having a trusted intermediary receive a supply assurance reply from said one or more suppliers.

8. The method of claim 1 further comprising the step of using a service selected from a group consisting of employing an XML transport protocol, tracking the supply assurance request that was sent to a supplier, and tracking the supply assurance reply that was sent to a customer.
